(19) United States
(12) Patent Application Publication
(10) Pub. No.: US 2024/0189907 A1
(43) Pub. Date: Jun. 13, 2024

(54) Hybrid Printing of Copper Conductive Material

(71) Applicants: VERSITECH LIMITED, Hong Kong (CN); ADVANCED BIOMEDICAL INSTRUMENTATION CENTRE LIMITED, Hong Kong (CN)

(72) Inventors: Remi Rafael, Hong Kong (CN); Kwok Leung Chan, Hong Kong (CN)

(73) Assignees: VERSITECH LIMITED, Hong Kong (CN); ADVANCED BIOMEDICAL INSTRUMENTATION CENTRE LIMITED, Hong Kong (CN)

(21) Appl. No.: 18/536,120

(22) Filed: Dec. 11, 2023

Related U.S. Application Data
(60) Provisional application No. 63/432,288, filed on Dec. 13, 2022.

(51) Int. Cl. B22F 10/18; B22F 10/20; B29C 64/118; B29C 64/194; B29C 64/371; B33Y 10/00; B33Y 30/00; B33Y 70/10

(52) U.S. Cl. CPC B22F 10/18; B22F 10/20; B29C 64/118; B29C 64/194; B29C 64/371; B33Y 10/00; B33Y 30/00; B33Y 70/10; B29K 2067/046

(57) ABSTRACT

A method for printing electronic components is based on the hybridization of Fused Deposition Modeling (FDM) and laser sintering. The method involves printing a layer of composite copper-based thermoplastic filament on a base. Then the filament is subjected to a laser beam so as to selectively remove the polymer matrix in a restricted area after printing to leave only the conductive particles forming a highly conductive network and sintering the conductive particles with the laser energy to reveal the conductive copper. Then, alternately repeating the printing and sintering steps on the filaments one on top of the other until a complete component of arbitrary geometry, including both insulative and conductive structures, is formed layer-by-layer.

### CROSS-REFERENCE TO RELATED PATENT APPLICATIONS

This application claims the benefit of priority under 35 U.S.C. Section 119(e) of U.S. Application No. 63/432,288 filed Dec. 13, 2022, which is incorporated herein by reference in its entirety.

### FIELD OF THE INVENTION

The present invention relates to the formation of copper conductive material and, more particularly, to the use of a specific composite material for 3D printing of highly conductive material.

### BACKGROUND OF THE INVENTION

Additive manufacturing technologies are the focus of multidisciplinary research and industrial efforts due to their attractive promise in fields such as mass personalization and decentralized manufacturing [1] because of their effect on reducing environmental impact [2] and providing new design strategies [3]. However, additive manufacturing of electronic devices is challenging because of the very different thermal properties between plastics and metals. To date, printed plastic parts are still incapable of electronic functions. In the age of information, when sensors are included in common objects to make them interactive and to include them in the internet of things (IOT), it remains difficult to directly integrate electronic components into a 3D printed object [4]. The 3D printing processes for thermoplastics used in mechanical structures, and the metals required for electronic interconnections are too different. In particular most metal printing methods involve high temperatures (>1000° C.), which is incompatible with common thermoplastics [5].

Some of the printing techniques, such as inkjet printing [6], material jetting [7] and direct writing [8] allow for the printing of both highly conductive inks and dielectric materials. However, they are restricted to liquid inks, their printing speeds are very low, and the conductive inks (which are generally based on silver) incur high costs, thus limiting the economic viability of large-scale applications.

Alternatively, conductive composite filaments have been developed for Fused Deposition Modeling (FDM) [9]. As the most common type of additive manufacturing, FDM is well adapted to print macroscopic, plastic based functional objects. Composite filaments composed of thermoplastics and conductive particles have been studied for a few years [11]-[13] and are believed to be one of the most economical methods to print conductive materials [10], [14]. In these filaments, the particle loading is superior to the percolation threshold. Hence the particles randomly dispersed in the polymer matrix are interconnected and form a conductive path (a network of touching particles) from any two arbitrary areas in the composite. The conductivity of the composite increases with particle loading and the aspect ratio of the particles [15]. However, to retain its thermoplastic properties, the composite must contain a large amount (more than 50 by volume %) of the polymer matrix [16]-[18], which inevitably limits the conductivity of FDM filaments. Furthermore, the polymer matrix generally covers the surface of the conductive particles, which increases the inter-particle contact resistance [19]. Thus, these filaments are not conductive enough to replace metal connections or vias. The most conductive filament commercially available, Electrifi, exhibits a resistivity of 6×10⁻³ Ω cm and screws or silver paste are still required at the interconnections [10].

This concept of using composite filaments has been previously exploited to create fully dense metal and ceramic objects [20], [21], however this technology (referred to as “Metal FFF”) requires a sintering step around 1100° C. in a furnace and is unsuitable for producing plastic-conductive hybrid parts.

### SUMMARY OF THE INVENTION

The present invention is directed to a new approach for printing electronic devices based on the hybridization of FDM and laser sintering. The system includes an FDM printer setup with a laser sintering function and a copper-based thermoplastic filament fully compatible with traditional FDM technology. Thus, instead of using mass heating in a furnace, the present invention uses a laser to selectively remove the polymer matrix in a restricted area after printing to leave only the conductive particles and form a highly conductive network by sintering the conductive network with the laser energy.

This filament is composed of native copper, cuprite oxide (Cu₂O), copper oxide (CuO) and starch particles encompassed in a Poly(lactic acid) (PLA) matrix. The filament is initially dielectric. However, it becomes highly conductive when exposed to intense laser radiation, i.e. “sintering.” During sintering, the PLA and starch disintegrate, and the copper oxides turn into a native copper mesh, forming a highly conductive interconnected network. By alternately repeating the printing and sintering steps, a complete 3D object of arbitrary geometry, including both insulative and conductive structures, can be printed layer-by-layer.

A custom 3D printer with 2 FDM extrusion heads and one laser head is used. The two extrusion heads are used to print PLA and copper composite respectively, while the laser is used to selectively sinter the composite. With this printing setup, a resistivity of 4×10⁻⁴ Ω cm and the capacity to print centimeter-scale polymer-conductive 3D objects is achieved. As proof of concept, the new setup was used with composite filaments to build a simple light emitting diode (LED) blinking circuit with a silicon-based timer chip and tin soldering.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is an SEM image of a line sintered on the surface of “the Virtual Foundry” copper filament, FIG. 1B is a picture of a sintered region at the surface of some “FormFutura” copper filaments and FIG. 1C shows test samples for a sintering experiment on “the Virtual Foundry” (top) and “FormFutura” (bottom) filament;

FIG. 2A shows the results of laser sintering of CuO/Starch powder mixes for different compositions and FIG. 2B shows the result of pure copper powder exposure to a near infrared laser;

FIG. 3A shows a setup for powder layer formation and FIG. 3B shows the geometry of a printed adaptor part for the setup;

FIG. 4 is a graph showing the size dispersion of copper and copper oxide powers determined by laser particle size analysis;

FIG. 5A is an SEM image of a dendrite-shaped copper particle synthesized by electrolysis, FIG. 5B is a schematic illustration of an electrolytic copper particle generation setup according to the present invention, FIG. 5C is a picture of sieved copper powder according to the present invention taken by optical microscopy and FIG. 5D is an XRD scan of the copper powder;

FIG. 6 shows a special spool for testing the minimum radius of curvature before rupture of a composite filament, where the inset shows a set of 3D printed die;

FIG. 7A is a perspective view of a hybrid printer according to the present invention, FIG. 7B illustrates parts of the printer and FIG. 7C shows an enlarged view of the printer with tower and axis designations;

FIG. 8A is a photograph of an interdigitated electrode representing the smallest features achievable using the printing setup of the present invention and FIG. 8B is an enlargement of the section in the red rectangle in FIG. 8A;

FIG. 9A is a picture of a composite sample with electrodes sintered on the surface; FIG. 9B shows stacked 3D maps of the resistance of a 1×10 mm electrode as a function of the sintering parameters, FIG. 9C is a graph of the resistance of an electrode as a function of the total energy per unit of surface for a different number of sintering steps, FIG. 9D is a graph of the resistance of an electrode sintered at 100% laser power at 5 mm/s as a function of the number of sintering steps and a picture of the corresponding electrodes, and FIG. 9E. shows compositions [CuO, Cu₂0, Cu] of the sintered composite as a function of the number of sintering steps (100% laser power at 5 mm/s) extracted by fitting XRD scans;

FIG. 10 shows the effect of laser sintering on PLA of different colors, while the table on the right side indicates the laser parameters used for each line of electrode;

FIG. 11A shows the top surfaces of a sample printed with and without ironing and FIG. 11B is a graph of the profiles of those two samples;

FIG. 12 illustrates the dispersion of the resistance measurements on electrodes sintered at 5 mm/s, 100% and 10 mm/s, 90% laser power for 1 to 5 sintering steps;

FIG. 13A shows the XRD scans of the composite as printed and of each of the individual components and FIG. 13B shows the scans for the composite material at all the stages of a ten-step sintering process;

FIG. 14A is a SEM picture of the top surface of the composite after being sintered four (4) times at 100% laser power and 5 mm/s, FIG. 14B is a cross section of the sintered composite in enhanced color (real color is used in the inset) obtained by optical microscopy, FIG. 14C shows graphs of the depth of sintering for different laser parameters measured on cross sections and FIG. 14D is a cross section of five (5) superposed sintered composite layers in enhanced color (real color in the inset);

FIG. 15 shows the failure mode of five (5) structures under 0.9 A when sintered at 100% laser power, four (4) sintering steps and 5 mm/s speed;

FIG. 16A is a picture of a printed test sample and FIG. 16B is a computer-generated image of the sample structure with the sintered layers separated from one another;

FIG. 17A is a picture of a printed sample using a “grid pattern” based Z via, FIG. 17B is a picture of a sample using a slope to allow conductive traces to cross each other and FIG. 17C is a picture of a simple electronic circuit using soldered conventional components to flash a LED;

FIG. 18A is an illustration of a printed sample stacking sintered layers over a large area (9.5 mm²) and FIG. 18B is a computer-generated illustration of a printed sample showing the formation of dielectric and mechanically strong pillars that sustain the pressure during printing and protects the sintered material;

FIG. 19A is a schematic representation of a grid pattern sintered at each layer of the sample in FIG. 18A (the real sample includes 101 layers) and FIG. 19B is a computer-generated image of the un-sintered composite material and the pillar structure it forms;

FIG. 20 is a 3D model of the structure presented in FIG. 17B with a left inset being a close-up of the slope geometry and a right inset being a close-up of the bridge structure; and

FIG. 21A is an initial design of a circuit using an EAGLE 9.6.2 and FIG. 21B is a 3D model of the circuit traces designed in Solidworks.

### DETAILED DESCRIPTION OF THE INVENTION

To verify the performance of the present invention, two commercially available copper composite filaments, the “Copper Filamet™” from The Virtual Foundry and “MetalFil—Classic Copper” from FormFutura were used for tests. Both filaments are PLA-based composites with respectively 90 and 80 mass percent copper loading. After printing 20×60 mm flat samples, a 10 W CO₂ laser and a 5.5 W 450 nm blue laser were used under various combinations of parameters to “sinter” the surface of the samples.

The first one from the Virtual Foundry is designed for “FFF metal printing.” In this technique the parts are printed with a normal FDM printer and then they are put in a high temperature furnace to completely remove the PLA matrix and sinter the particles together, producing a dense metal part. Accordingly, this filament is optimized to have a very high copper content. As a consequence, this filament is brittle and can be difficult to print. The thermoplastic matrix (PLA) is also selected for being completely removed with very little residue during the high temperature process.

The second filament from FormFutura is designed to “look and feel like copper casted objects.” To facilitate printing, it only contains 80 w % copper making it less brittle and compatible with any FDM printer (including Bowden tubes). Once printed it was sanded and a patina was applied to imitate pure copper. According to the tests on this sample, this filament can also be turned into dense copper by the same high temperature process, but the shape of the printed object deforms heavily.

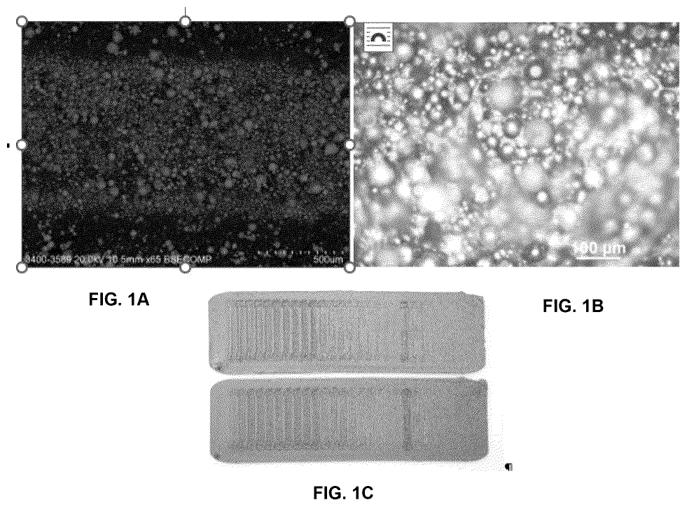

Under laser sintering both of these filaments react similarly: The PLA is vaporized leaving the copper particles bare, but no conductive network is formed. Instead, the particles are expulsed and oxidized. FIG. 1A shows an SEM image of a sintered line on The Virtual Foundry composite. All the particles present on the sides of the line (top and bottom) have been expulsed during sintering. The other particles in the un-sintered regions are covered with PLA and are invisible to the SEM. FIG. 1B shows a sintered region on the FormFutura composite. The various colors correspond to the different stages of oxidation (red for Cu₂O and black for CuO). FIG. 1C shows two test samples with electrodes engraved with different laser parameters. All sintering conditions (laser power, laser speed, number of sintering) were maintained in the various tests on the composites. In each case the conductivity was measured, but all samples remained insulative.

The results showed that PLA could be successfully removed, leaving a high concentration of copper particles. However, the copper particles were oxidized in the process and no combination of parameters could yield a conductive result. Additionally, the copper/copper oxide particles resulting from those experiments are in the form of a loose powder. They can be detached by a strong flow of air and are sometimes expulsed during the sintering process.

This result was expected because PLA is vaporized below 450° C. but copper is sintered around 1100° ° C. The laser energy in the experiments was high enough to vaporize the PLA but too low to thermally sinter (i.e., partially melt) the particles. Additionally, numerous studies focusing on selective laser sintering show that an oxygen-deprived atmosphere is required for metal sintering, as oxidation is the predominant phenomenon in the presence of oxygen [23], [24]. The most energy intensive parameters tested with a CO₂ laser cause the sample to catch fire, but the copper particles were still not sintered. Those experiments show that the classic method of sintering (heating close to the melting point) is not applicable in the context of polymer multi-material printing, because the temperatures involved are too high.

Alternatively, sintering (i.e., bridging adjacent particles) can be achieved by a chemical reaction causing the deposition of a native copper layer on the copper particles [25], [26]. This effect has been exploited in the context of Intense Pulsed Light (IPL) sintering using a metal-organic compound: copper formate [27]. Copper formate spontaneously decomposes around 200° ° C. to form native copper and volatile compounds. Formic acid can also have a reducing effect on copper oxide under IPL to produce native copper [28]. However, both copper formate and formic acid are incompatible with the temperatures associated with FDM printing (i.e., around 210° C.). Instead, starch and cellulose have been shown to produce various reducing agents during thermal degradation [29], and do not degrade under normal printing temperatures.

To evaluate the reducing effect of starch, copper oxide and starch powders were mixed together, spread on a glass slide, and exposed to a laser beam. The results indicate that copper oxide is reduced, and a conductive copper layer is left. In comparison, copper powder exposed under the same conditions without starch oxidizes during laser treatment.

The thermal decomposition of starch produces a multitude of chemical species some of which can function as efficient reducing agents. This reducing effect, hinted at in the literature, has however not been extensively studied as the chemistry of laser vaporization is complex and niche in terms of application. To assess the influence of starch as a reducing agent under laser exposure, powder mixes of CuO and starch (both chemical in powder form) were prepared. The mix composition was varied from 75 to 60 w % CuO by 5 w % increments and the resulting powders were deposited onto glass slides to form a homogeneous layers about 300 μm thick. A near infrared CO₂ laser was then used to sinter individual lines on the powder sample. The laser parameters were the object of an optimization process.

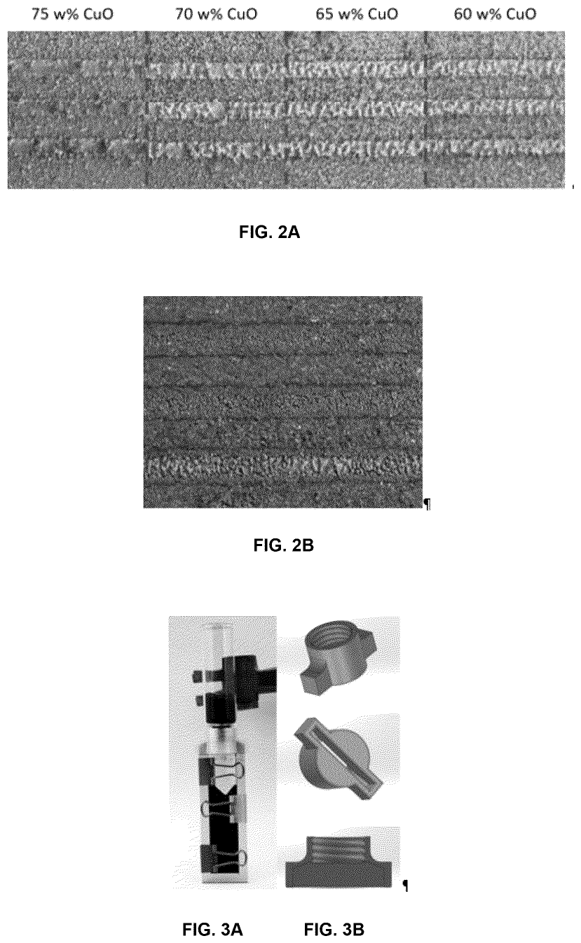

The FIG. 2A shows optical pictures of four (4) samples with various compositions (75, 70, 65 and 60 w % CuO) sintered using the same parameters. The three (3) horizontal lines present in each image correspond to the trajectory of the laser, and native copper can be recognized in each of the sintered sections. Conductivity measurements and EDX analysis confirm the identification of native copper as the only copper atoms present on the EDX and the 65 w % sintered line is conductive.

At 60 w % CuO, black copper oxide can still be clearly discerned after sintering, indicating that the amount of starch available was insufficient to trigger the reduction of all the CuO. On the opposite side, at 75 w % CuO, no copper oxide remains but the amount of native copper is reduced compared to the 65 w % sample. This is explained by the lower amount of copper atoms initially present in the mix. The optimum conditions (assimilable to stoichiometric conditions) are between 70 and 65 w % CuO with 30 to 25 w % starch.

The laser sintering and laser melting of pure or native copper powder has been well studied in the context of powder bed fusion additive manufacturing. In this technique an inert gas atmosphere is used during printing to impede the oxidation of the powder during the process. It is thus expected that copper powder under ambient atmosphere will oxidize when exposed to a medium power laser. However, some results with Intense Pulsed Light (IPL) sintering and laser sintering suggest that the reduction of copper by light irradiation is possible without additives dedicated to the copper reduction. Sec, Cheng, C. W., & Chen, J. K. (2016) DOI: 10.1007/s00339-016-9814-3 and Chiu, P. H. et al. (2021) DOI: 10.3390/nano11071864

For this reason, the effect of laser irradiation on the copper powder of the present invention was evaluated. To this end, 300 μm thick copper powder layers were prepared on glass slides and exposed to a 10 W near infrared CO₂ laser. The laser parameters (scan speed, laser power, focus) were varied over the whole available range but the results were always the oxidation of the copper/Cu₂O mix to the CuO state. FIG. 2B shows the result of this experiment for three (3) sets of parameters. It is representative of the general results with the darker material being CuO. Under the most intense parameters (low speed, high power) the copper powder was completely burnt producing a large volume of fumes and leaving the glass substrate bare.

Due to the very poor flowability of the powder mixes used (linked to the dendrite geometry of the copper powder) it was not possible to use a rod to simply spread a thin powder layer on a glass substrate, nor to compress the powder between two flat surfaces. Instead, a method was used in which two glass slides were fixed together while separated by a Kapton spacer. A glass vial was located at the extremity using a part that was 3D printed in thermoplastic polyurethane (TPU). The system was then agitated using a mechanical stirrer until the powder dropped between the slides to form a compact layer. The slides could then be carefully separated to leave a homogeneous powder layer. FIG. 3A shows the setup used and FIG. 3B shows the printed adaptor part.

Based on these observations, a test was conducted on a composite recipe composed of 55V % of a PLA matrix and 45V % of particle mix. This particle mix is composed of 60 W % copper powder, 30 W % CuO and 10% Starch (“the composite recipe”). PLA was chosen as a matrix because it has excellent printing characteristics and a very low ash content (almost no residue is left after sintering) [31]. Additionally, PLA is easily available and can be bio-sourced and biodegradable. Copper oxide was purchased in powder form with a mean particle size of 5 μm. Alimentation grade corn starch was also used. However, the copper powder was produced in a lab by an electrolytic process to achieve high aspect ratio and small size (<20 μm) particles.

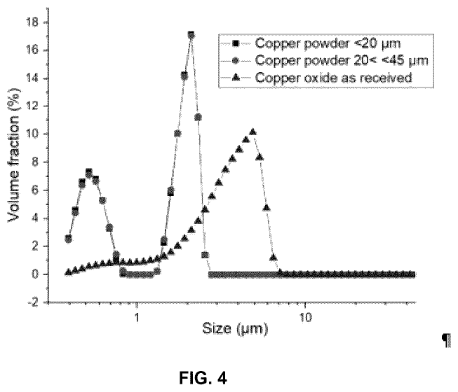

An analysis of the particles was conducted on the copper and copper oxide powders using a laser particle size analyzer, Beckman Coulter LS13320 6605637. The results, in FIG. 4, show that the CuO particles have a size repartition centered on 5 μm and a maximum dimension of about 8 μm. However, the results for the copper powder could not be directly determined.

For this experiment not only was the native copper powder of the present invention (sieved below 20 μm) tested, but also a fraction of the powder was tested that was too big to pass the 20 μm sieve and remained between the 20 and the 45 μm sieves. Those two fractions are indicated in the FIG. 4 under the names “copper powder <20 μm” and “copper powder 20<<45 μm”.

The size repartition deduced by the particle size analyzer is almost identical for both fractions. Furthermore, it is known that the particles contained in the 20<<45 μm portion have at least one dimension bigger than 20 μm as they couldn't pass through a 20 μm sieve. However, no peak could be found in this region. This phenomenon is explainable by the specific geometry and aspect ratio of the particles. The analyzer uses the diffraction of the laser to deduce the size of the diffracting object. With a dendrite shaped particle all the branches create a diffraction pattern. The size identified by the analyzer thus corresponds to the diameter of the branches and not the full size of the particle. The bimodal distribution may be caused by the cuprite oxide crystals, but this hypothesis is difficult to confirm.

A better size characterization of the copper powder was attempted using SEM, but two other issues prevented it: On the one hand, at high particle density the complex particle geometry made it impossible to distinguish single particles from aggregates. On the other hand the dispersion techniques that were used to achieve very low density led to the segregation of big and small particles at different locations, making it impossible to select a representative sample for manual counting. For those reasons no other particle size characterization could be obtained.

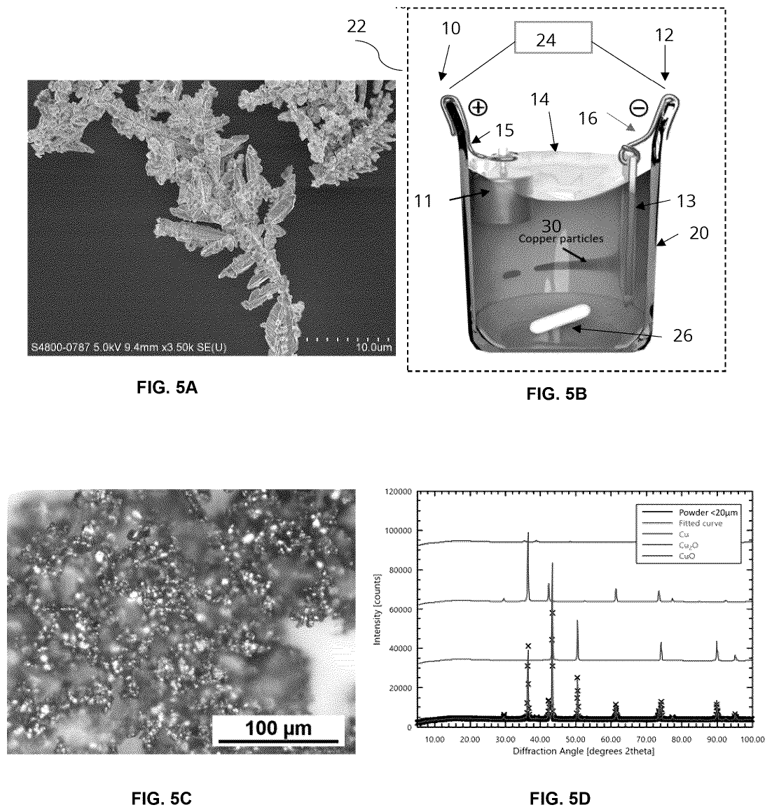

During tests on commercially available copper filaments, it became apparent that the vaporization of PLA during laser sintering generates a large amount of gas. This gas can blow the particles away and prevent the formation of a conductive network. To prevent that, electrolytic copper particles were used. The specific dendrite shape of electrolytic particles, illustrated in FIG. 5A, ensures that neighboring particles are interlocked, forming a loose network that lets the gas pass without getting blown away.

The electrolysis setup of the present invention is illustrated in FIG. 5B. It is composed of two copper electrodes 10, 12 dipped in a copper sulfate solution 14 [32]. The literature on thermoplastic composite shows that small particles improve the flowability of a molten composite [33], [34], and in the context of 3D printing, the particles should be at least one order of magnitude lower than the dimension of the extrusion nozzle to prevent clogging [35], [36]. Accordingly, the electrolysis parameters were optimized to minimize the copper particle size and a 20 μm sieve was used to remove any bigger particles.

The copper particle size selected should be at least one order of magnitude lower than the FDM nozzle diameter and as small as possible to improve the molten flowability of the composite. However, the particles should also have large aspect ratios to maximize the particle interconnection during sintering and should be “significantly” larger (4 to 20 times) than the oxide particles. The 20 μm size of the copper particles used in this embodiment of the present invention is a compromise between these considerations and the capabilities of the electrolytic process. The native copper particles should be between 8 to 45 μm based on the electrolytic copper particle sizes available on the market.

The morphology of the copper particles produced by electrolysis depends on the voltage bias, the temperature and the ion concentration in the electrolyte. At low voltage bias the copper reduced at the negative electrode forms a homogenous layer (electroplating mode) while a higher potential difference is favorable to the formation of numerous crystal nuclei, and multiple dendrite forms. Those dendrites constitute an interconnected mesh that can be broken into multiple particles by mechanical agitation. For this reason, high voltage yields high aspect ratios and small size particles. The number of copper ions reduced per unit of time, and thus the particle synthesis rate, is proportional to the current. High current and high voltage bias are thus desirable to achieve a high synthesis rate and low particle size. However, the mesh formed by the dendrites on the negative electrode increases its surface area and decreases the equivalent resistance of the setup. The joule effect inside the electrolyte also increases the temperature. Higher temperature increases the ion mobility and the synthesis rate but can also cause local ebullition and a drop in equivalent resistance. To maintain the right voltage/current ratio (i.e. equivalent resistance) the setup was placed in a large (6 litter) water container that served as a temperature buffer and magnetic agitation was used to break the copper mesh during synthesis.

The process for generating the copper powder used in the present invention is as follows: An electrolyte was prepared by dissolving 15 g of copper chloride pentahydrate into 600 ml of deionized water. A rectangular copper electrode 12 was used for the reduction side. The dimensions of the immersed part were 10×50×1.5 mm. On the other side electrode 10 consisted of two roughly cylindrical copper ingots 11, 22 mm in diameter and 22 mm in height. See FIG. 5B. The ingots were maintained in the electrolyte with copper wires 15, 16 so that only the top surface of the ingot emerged. Both electrodes were separated by 50 mm inside a closed glass container 20. This container was placed in a large box 22 filled with 6 liters of water to increase thermal dissipation and limit the temperature. The copper ingots were replaced when about 80% of their mass was consumed. A DC power supply 24 [KPS605DF from Wanptek] was used to apply a constant current flow through the system. A magnetic bar 26 was added to the system and the stirring speed from a stirrer was adjusted to rotate the bar 26 sufficiently to break the copper dendrites and to keep a voltage bias at 15+5 V. When initiating the reaction at ambient temperature, the system resistance is high and a bias of up to 60V was applied. The system then heated up in about 25 min and the temperature stabilized at 45+10° C. After 5 to 10 h, the powder 30 accumulated in the container and had to be pipetted out to prevent pseudo short circuit and local ebullition.

The yield of the electrolysis process was evaluated by running the setup for 6h 20 mn while monitoring the current and voltage. The powder generated was then extracted and measured. For this experiment the average voltage bias was 21±2V and the current was stable at 5.17 A. The energy consumed was thus about 700 Wh while 32.7 Ah passed through the setup. After drying 26.8 g of copper powder was extracted. Neglecting the weight of the oxygen introduced in the copper powder by oxidation, 1 atom of copper powder is produced for every 2.5 to 3 electrons. The powder obtained was sieved and 37.5 w % was below 20 μm, 38.4 w % between 20 and 45 μm and 24.1 w % was bigger than 45 μm.

Three approaches were tested to increase the portion of small particles: Grinding the powder in a mortar, adding steel balls during the sieving process and agitating the particles in suspension in water using a high-pressure water gun. All of these approaches were efficient in reducing the particle size (up to 90 w % below 20 μm for mortar grinding) but also impacted the aspect ratio of the particles. Consequently, those approaches were not employed so as not to introduce a new variable.

After synthesis and during the drying process, the copper particles oxidize in contact with the atmospheric oxygen. This process, well documented for copper particles, is evident in FIG. 5C. This real color image taken by optical microscopy shows multiple deep red crystals typical of cuprite oxide (Cu₂O). To ascertain the composition of this copper powder, the XRD scans visible in FIG. 5D were conducted. In FIG. 5D the raw data points in black are superimposed with the fit achieved with PROFEX software. The green, blue, and purple curves correspond to the components of this fit associated with Cu, Cu₂O and CuO, respectively. Using the Profex 5.0.1 software the crystalline phase composition of 55 W % Cu, 43 W % Cu2O and 2 W % CuO was extracted. However, it was not possible to quantify the uncertainty associated with this method and the absolute values should be considered as an approximation. Herein the expression “copper powder” always refers to this mix of native copper and oxides achieved after sieving.

To prepare the composite filament, all the components (PLA, starch, copper oxide and coper powder) were dried and extruded with a twin screw extruder to form a 1.75±0.1 mm diameter filament. High particle loading PLA composite suffers from an increased brittleness which can cause issues during printing [38]. This brittleness can be quantified by the minimum radius of curvature before rupture. The filament of the present invention breaks around 60 mm compared with the 70 mm for the copper composite from the Virtual Foundry and 10 mm for the FormFutura. To account for this fragility, a special spool with a 25 cm diameter was formed (3D printed) to roll the composite filament. It was designed with a low friction spool holder to minimize the tension. No filament breaking was experienced while using this mechanism during the printing process.

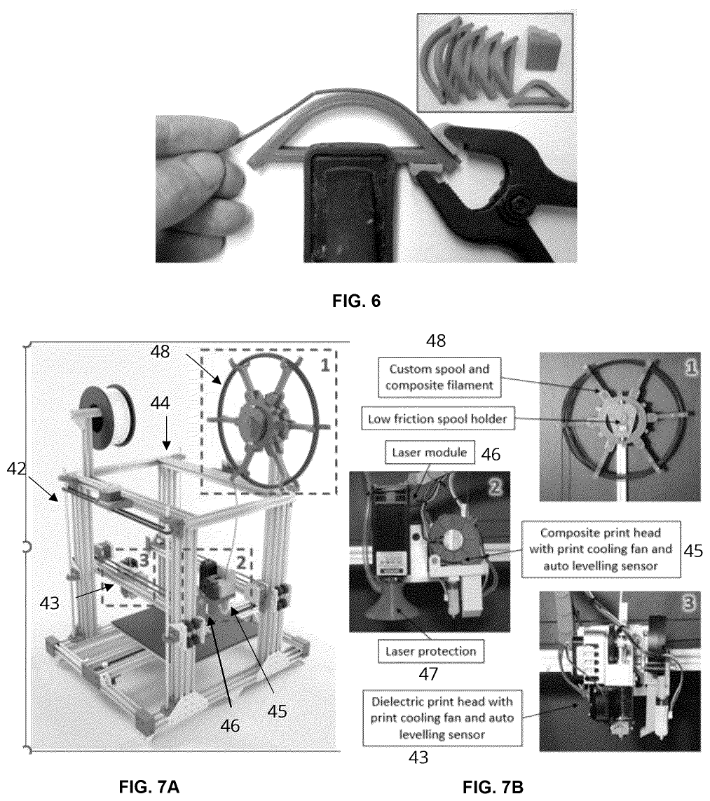

In PLA/metal particle composites, a high particle loading impedes deformation of the material before rupture and changes the fracture mode from ductile to brittle. In practice this can cause the composite filament to be difficult to handle and to break during printing because of the movements of the printing head and the tensions in the feeding system. These issues can be mitigated by reducing the printing speed, minimizing friction in the spool holder, and optimizing the spool position. However, a figure of merit is required to compare different filaments. To quantify the brittleness of the filament of the present invention the minimum radius of bend of the filament before rupture was measured. To carry out this measurement a set of dies forming a 90-degree bend with a radius of curvature varying from 10 to 80 mm was formed. A length of filament was then fixed at one extremity and bent over the shape. See FIG. 6 which illustrates this process.

The lengths of tested filament were selected to be 1.75±0.05 mm in diameter as this parameter impacts the local strain on the skin of the filament. When the filament was permanently curved due to storage in the spool, it was fixed to the die so that the test bending direction was perpendicular to its natural curvature. This test was applied to all the filaments cited and the results showed that the most brittle filament is the copper composite from the Virtual Foundry with a breaking radius of 80 mm, closely followed by the filament of the present invention with a radius of 70 mm. In comparison the copper composite from FormFutura breaks around 10 mm and pure PLA deforms without completely breaking even at 0 mm. Those results are in good accord with the “perceived printing difficulty” of the inventors.

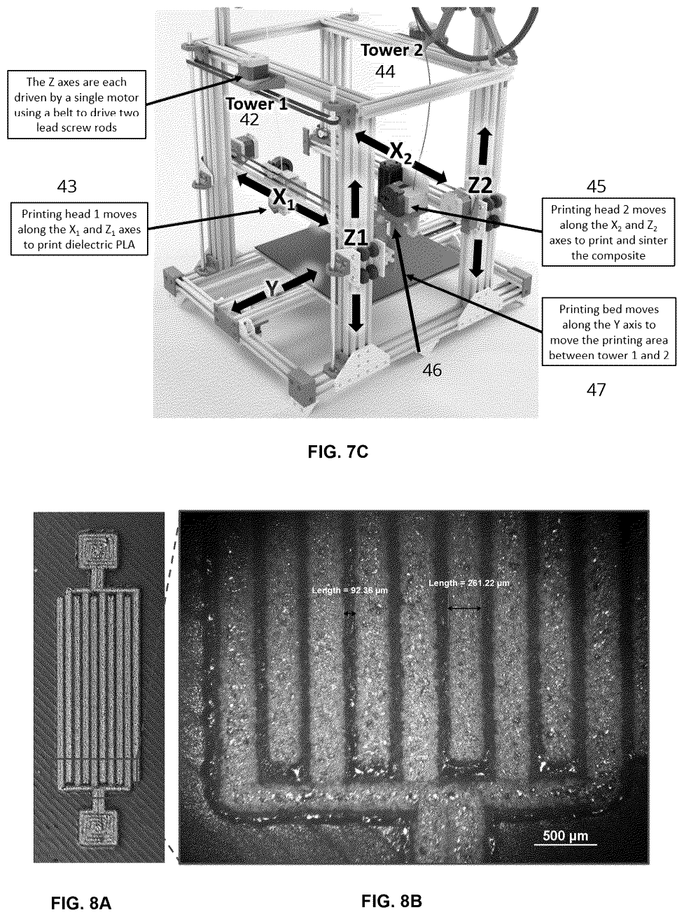

FIG. 7A shows a perspective image of the custom 3D printer of the present invention and FIG. 7B shows close-up images of its essential components. Built for under $1,000 USD this design uses commercially available printer parts. To enable printing and sintering of the composite at each layer of the print, a special printer equipped with 2 FDM extruders and a laser head are required. Since no such printer is available on the market, one was designed and built. The printer of the present invention uses the axis organization of the open source ZIDEX model. The printer has a two “towers” design with individual Z and X axes that move independently while the printing bed, associated with the Y axis, moves the printing area to either tower. FIG. 7C shows the orientation of each axis. The first tower 42 has two vertical shafts with a rail between them that bears the movable FDM head 43 dedicated to the dielectric PLA filament. A bar runs in the Y direction between the first and the second tower 44. This bar bears the composite FDM head 45 and the laser 46. A printing bed 47 is at the base of the frame and it is movable in the Y direction between the two towers. The rails and bar on the towers form a sub-frame that is moved vertically by a motor. Thus, movement of the extrusion heads, laser and printing bed allow for the creation of any shape. The composite filament is fed to the FDM heads from wheel 48 on the top of tower 2. The FDM heads used were the compact, direct drive GIULY All Metal E3D Titan Acro Extruders. Direct drive extruders are necessary due to the brittleness of the composite filaments as Bowden tubes cause more bending and breaking. The laser module from TIANGREEN has a 450 nm wavelength and 5.5 W nominal output. The laser beam is surrounded in part by a printed hood 47 to protect against reflected light. Each printing head is equipped with a Z probe “BL touch” to allow automatic alignment. The setup is controlled by a controller on a Duet 3D motherboard.

The G-codes (printing files) for the printer were generated with the open-source slicer software “Ultimaker CURA 4.9.1,” which was modified using custom Python routines. Most printing files used in this device were generated using Solidworks to design the 3D models and CURA to “slice” it and produce a G-code. However, CURA is not adapted to directly generate a G-code for both the printing and sintering steps. From a programming standpoint sintering consists in going over an already printed area with another toolhead. CURA interprets this “overlap” as a potential collision and cannot program that type of trajectory. To produce the final printing files, two files were generated: One including the commands to print both the dielectric PLA and the composite, and the second including only the sintering commands. Then a Phyton based routine was designed to parse through those files and generate a new G-code introducing the sintering section at the end of each composite printing section.

To minimize the clogging issue, the composite filament was printed through a 0.6 mm nozzle (line width was accordingly set to 0.6 mm). The layer height was set at 0.1 mm to match the sintering depth (discussed below). Other printing parameters are explained below.

The most critical step of the hybrid printing method of the present invention is the laser sintering during which the initially dielectric composite is turned conductive. The parameters associated with this sintering are the laser focus, the hatch distance (distance between two successive laser scan), the scanning speed, the laser power, and the number of sintering passes.

The focus and the hatch distance are interdependent as the hatch must be smaller than the laser spot size to yield a homogeneous sintering. In the experiments conducted on the present invention, the hatch distance was set at 150 μm, and the focus lens of the laser module was tuned to achieve a homogeneous sintered layer after 3 scans. The laser spot was then measured at approximately 260 μm. The focus and hatch were then kept constant through all the experiments.

In order to assess the minimum feature size achievable with the present hybrid printer an interdigitated electrode pattern was prepared. This design, visible in FIGS. 8A and 8B, consists of two comb-shaped electrodes overlapping over 8 mm. Each “comb tooth” corresponds to a single pass of the sintering laser and is approximately 260 μm wide. This dimension also corresponds to the laser spot size. The un-sintered area separating the electrodes is approximately 90 μm. The separation programmed in the G-code between adjacent teeth is 350 μm. Measurements made with a multimeter and micromanipulators confirm that there is no short circuit between the two half electrodes and the extremity of each tooth is electrically connected to the contact pad on its side.

The printed structure used for this sample is identical to those presented in FIG. 2B. Sintering was done at 5 mm/s, 100% laser power and one single sintering step under a flow of nitrogen. The tooth thickness (here 260 μm) is dependent on the focus of the laser. This sample uses the focus position optimized to form homogeneous sintered faces with a 0.15 mm hatch.

At this scale the usual G-code generation process (designed as a 3D model and sliced using CURA) is not appropriate due to the geometrical approximations made by the software when saving as an STL and slicing. These approximations lead to short circuits in the angles and extremities of the pattern. For this reason, the G-code for this pattern had to be made manually.

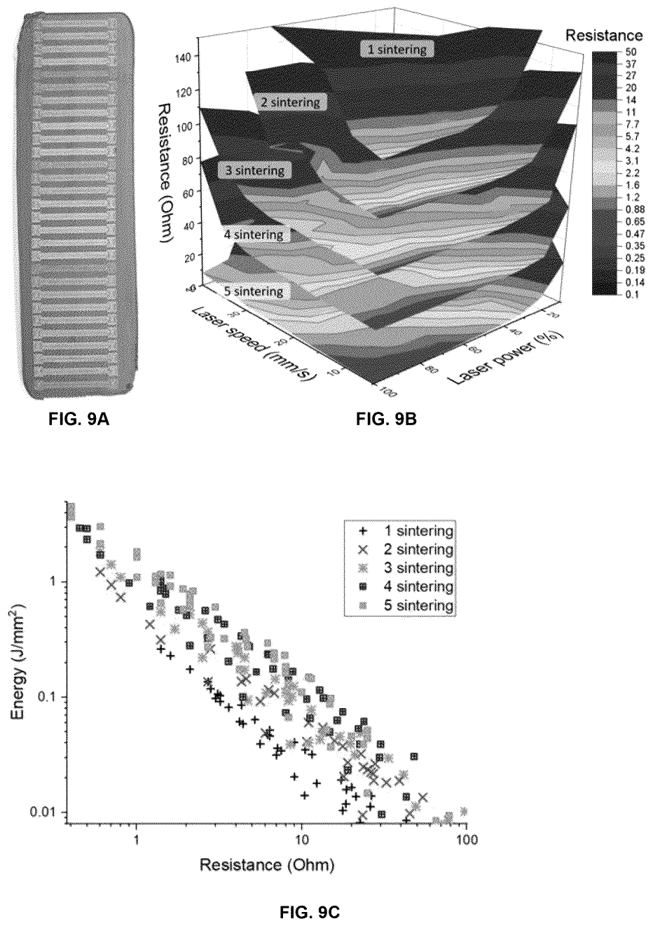

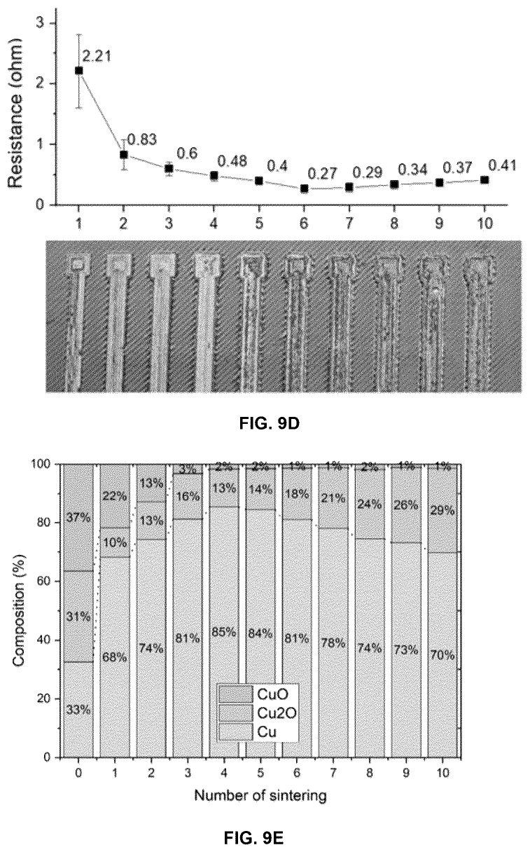

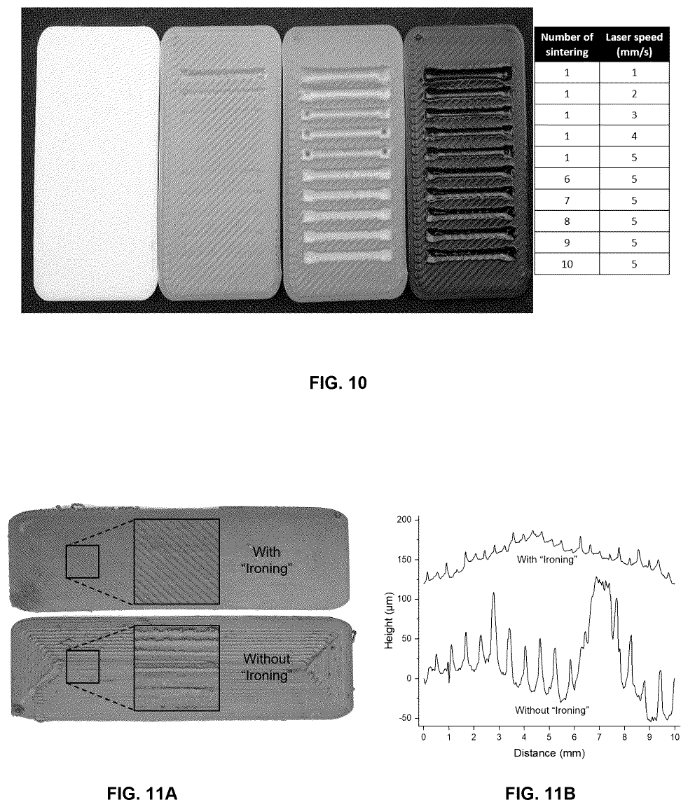

To test the effects of the other parameters, a 20×60 mm flat sample composed of a 0.6 mm composite layer was printed on top of a 0.8 mm PLA base as shown in FIG. 9A. The PLA base is used to ensure the mechanical robustness of the sample. It allows use of a low composite thickness, thus saving filament. White PLA filament was selected as it is not affected by exposure to a blue laser, even using the most energy intensive parameters, as indicated by the test results of FIG. 10. To minimize the effects of surface rugosity, the samples were printed using the “ironing” option of the CURA slicer. Then the laser was used to sinter the shape of 1×10 mm electrodes terminated by two 1.5 mm square pads.

When printing functional 3D objects with embedded conductive traces the composite is printed and sintered directly on the surface of normal PLA. At that time the sintering step may cause damage to the support PLA due to the partial transparency of the copper layer and the local heating. Thus, a test was conducted on the effect of the blue laser (450 nm) on PLA filament of various colors. Four (4) PLA filaments from LANBO were tested: white, blue, orange, and black and various sintering parameters were used. FIG. 10 shows the result of laser sintering on the various colors of PLA substrate. The table on the right side indicates the sintering parameters used for the corresponding line. Laser power was kept constant at 100%.

While orange and black PLA are largely impacted and wide vaporized zones are visible, the blue PLA is only mildly affected and only the most intense parameters leave a trace. The white PLA is completely unaffected, and no trace of any degradation is visible, as stated above.

This result is explained by the high transparency of the PLA for blue wavelength light. The white pigment scatters the laser light, and a very low amount is absorbed at the surface. The blue pigment is slightly less absorbent but reflects and scatters most of the energy leading to reduced damage. The orange and dark pigments strongly absorb the light and cause a large local temperature increase. For this reason, white PLA filament was selected for all the samples.

The printing parameters are as follows: For all prints the bed temperature is set at 50 degrees and a prime tower is included with a minimum extrusion volume of 6 mm³. No build plate adhesion feature, supports or ooze shield is used. Dielectric PLA (white PLA from LANBO) is printed using a 0.4 mm nozzle (line width is set at 0.4 mm) at 204 degrees with 100% infill. Layer height is 0.2 mm, printing speed is 60 mm/s reduced at 30 mm/s for outer layers, and print cooling fan is used after the first layer. The standby temperature is set at 175 degrees.

The composite filament is printed with a 0.6 mm nozzle (line width is set at 0.6 mm) at 215 degrees. The wall thickness is set at 100 mm (the whole printed part is considered a wall) to ensure the printing direction is aligned with the main direction of the printed feature and to minimize holes. The layer height is 0.1 mm and the printing speed is 20 mm/s for all feature types. The flow rate is set at 105% to remove any holes in the printed layer. The movement speed is reduced to 40 mm/s to limit the efforts imposed on the brittle filament. A small coating volume of 0.1 mm³ is used with a coasting speed of 80%. The retractation distance is set at 1 mm with 1 mm³ extra prime amount. The cooling fan is disabled for the composite and the standby temperature is set at 150 degrees.

Using a high extrusion coefficient of 105% allows for the printing of fully dense parts and ensures that the printed conductive traces are not discontinued by holes in the printed layer. However, over-extrusion can cause the formation of “ripples” when the molten filament is compressed against the surface of the printed object and expulsed to the side. This phenomenon can be minimized by careful parameter optimization, but variations in the diameter of the filament of the present invention complicate this process. To correct this issue, the “Ironing” option of CURA is used. The “Ironing” process consists in scanning the whole object's surface with the hot nozzle to melt away the peaks and fill the gaps (Ironing flow was set to 0%). In the experiments Ironing drastically improved the surface quality and was systematically employed. However, the composite stagnant in the nozzle for the whole duration of the process tended to degrade and had to be purged so as to not cause clogging issues. FIG. 11A shows the top surfaces of a sample printed with and without ironing. FIG. 11B is a graph of the profile of those two samples. The profiles were taken perpendicular to the peak lines over 10 mm using a stylus profilometer Bruker Dektak XT.

Multiple electrodes were sintered while varying the laser power from 10 to 100% with a 10% increment (maximum nominal output is 5.5 W). The scan speed was varied from 5 to 40 mm/s by 5 mm/s increment and the number of sintering steps from 1 to 5. The resistance of individual electrodes measured with a digital multimeter is summarized in FIG. 9B. FIG. 9B is presented as stacked 3D maps with the laser power and laser speed as X and Y axis, and resistance as the Z and color axis. The five maps achieved using 1 to 5 sintering steps are stacked with an offset in the Z direction to facilitate the reading. This map shows that for a given number of sintering steps the lowest resistance is always achieved with the most energy intensive parameters (5 mm/s and 100% laser power).

This trend is also visible in FIG. 9C, which presents the same set of data as FIG. 9B but shows the resistance as a function of the total energy received by the sample (the sum of the energy for each sintering step). The overall lowest resistance is achieved for 5 sintering steps with a resistance of 0.4Ω.

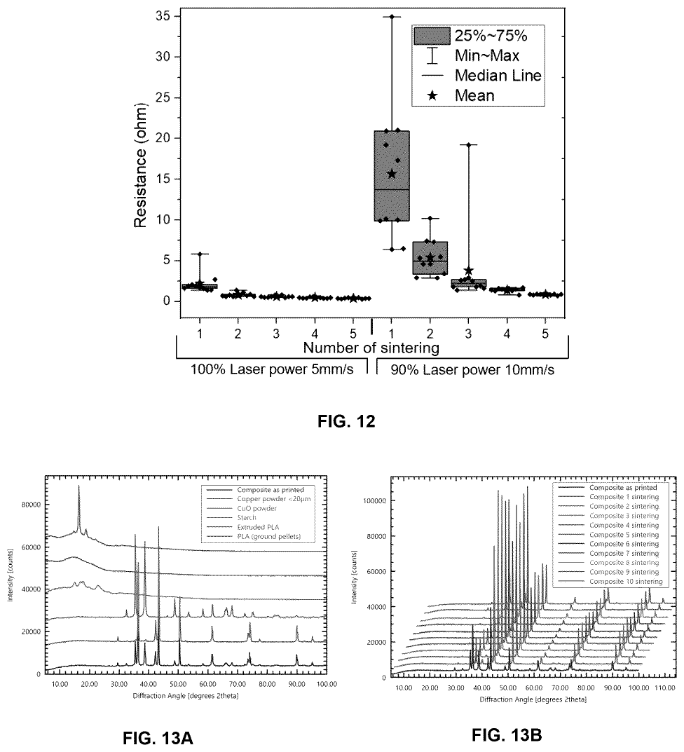

FIG. 12 illustrates the dispersion of the resistance measurements on electrodes sintered at 5 mm/s, 100% and 10 mm/s, 90% laser power for 1 to 5 sintering steps. For each parameter set, 10 samples are shown. From this figure it can be seen that the resistance variability is strongly dependent on the process parameters and decreases when the sintering energy decreases. Due to high variability for one single sintering step the results presented in FIG. 9B (stacked 3D maps) for one sintering are an average over 5 samples. However, due to the low amount of composite filament available the points for two or more sintering steps correspond to a single experiment.

As these results do not show a minimum in resistance, the number of sintering steps was increased while keeping the speed at 5 mm/s and laser power at 100%. FIG. 9D shows the results of these experiments with the average resistance over ten samples as a function of the number of sintering steps, and the optical image of the electrodes sintered under those conditions below. The resistance continues to decrease and reaches a minimum of 0.27Ω for 6 sintering. However, a reddish-brown layer begins to grow on the surface of the electrode after 4 sintering.

To confirm the nature of this layer, XRD scans were taken for each set of sintering conditions. The composition extracted from these scans by fit is presented in FIG. 9E. As stated previously, the exact percentage values should be considered approximate, but the trends can be deduced from these results: Up to 4 sintering steps, the percentage of copper oxides (Cu₂O and CuO) decreases continually, and the proportion of native copper reaches a maximum at 4 sintering steps. After that, the proportion of cuprite oxide gradually increases.

FIG. 13A shows the XRD scans of the composite as printed and of each of the individual components. All the peaks discernable in the composite correspond either to the copper powder or to the copper oxide. The absence of starch peaks is not surprising given its low amount (4.5 w %) in the composite and the large dispersion of its peaks. PLA in pellet form is semi-crystalline and shows a strong peak at 16.5 degree (see scan “PLA (ground pellets).” However, the extrusion process produces amorphous PLA without any noticeable peak. This is shown in FIG. 13A from the scan “Extruded PLA.” To produce this scan, pure PLA pellets were extruded using the same process as the composite extrusion. The resulting filament was then printed and scanned under XRD. FIG. 13B shows the scans for the composite material at all the stages of sintering.

All XRD scans were carried out on a Rigaku SmartLab in Bragg Brentano configuration between 5 and 100 degrees at a scan speed of 8 degree per minute and a sampling rate of 10 points per degree. The copper source was driven at 45 kV and 200 mA with a nickel KB filter on the path of the secondary beam. Profex 5.0.1 was used to fit the results. The phase profiles used for the Cu and CuO phases are respectively the references 04-009-2090 and 04-007-1375 from the PDF-4+ database. The profile for the Cu₂O phase was downloaded from the Crystallography Open Database where it is referenced under the code 9007497.

This confirms that the decomposition of PLA and starch during laser sintering causes the reduction of the oxides. After 4 sintering steps, only copper and copper oxides remain at the surface of the sintered area. Upon further exposure to the laser, this top surface oxidizes again due to atmospheric oxygen. This mechanism suggests that it is preferable to increase the laser power and to keep the number of sintering steps low to achieve low resistance.

The extrusion of the copper composite was according to the following method. PLA pellets purchased from Xiamen Keyuan Plastic CO, were ground to below 500 μm particle size using an IKA MF 10 grinder. This step was taken to promote the homogeneous mixing of all the component powders together and to achieve a uniform repartition in the composite while minimizing the hot mixing time (we observed that prolonged passage in the extruder leads to the production of gases and the reduction of copper oxides presumably due to the degradation of PLA and/or starch). After drying for one night in a food dehydrator at 68 degrees, 100 g of PLA powder was then mixed with 217 g of copper powder, 108 g of CuO and 36 g of starch. The CuO used was 99% copper(II) oxide from J&K Scientific. The starch is general alimentation grade Meadow corn starch. The powders were thoroughly mixed before being extruded in a PRISM TSE 16 TC twin screw extruder. From the feeding side to the extrusion side, the temperatures programmed in the controllers of each five zones were 165, 180, 185, 190 and 175 degrees. The filament produced was cooled with air and water and driven by a belt puller. The belt speed was adjusted manually to obtain a 1.75 mm diameter filament.

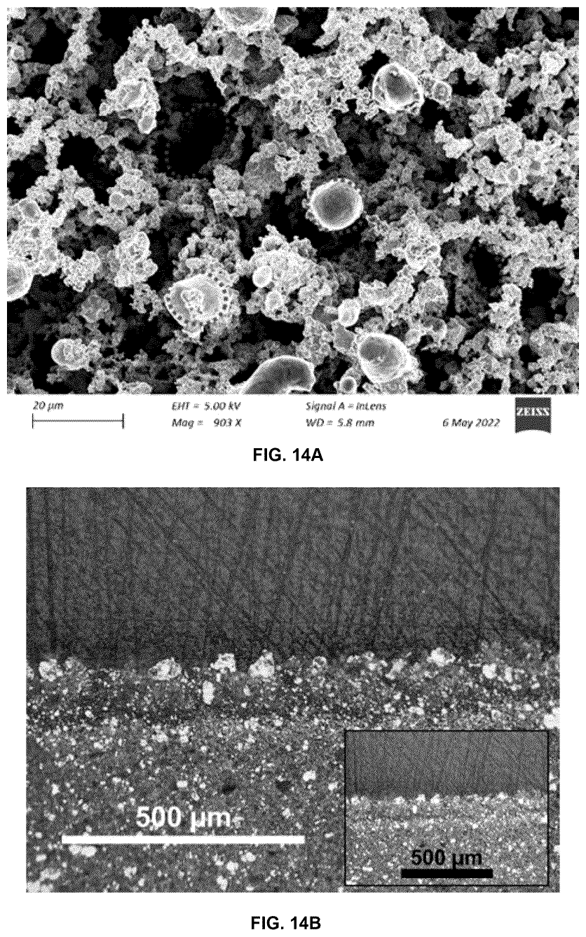

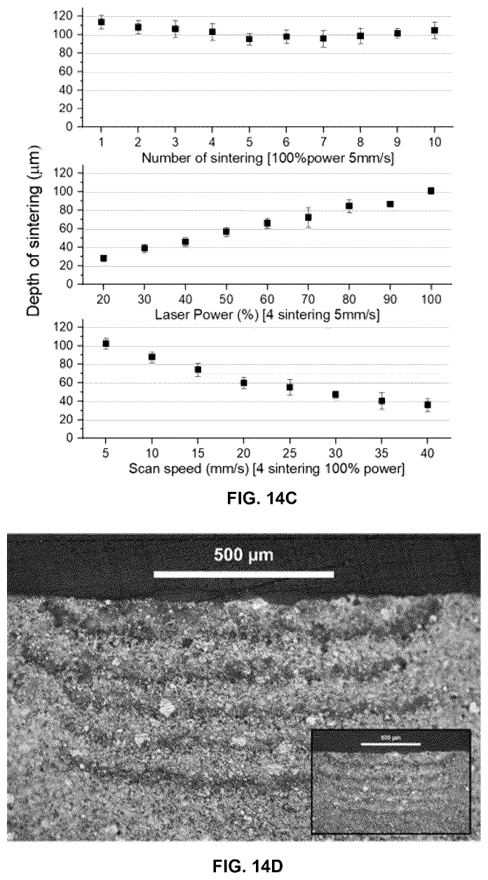

PLA composes 55V % of the composite and its removal leaves a porous copper structure. SEM observations of this structure shows regularly dispersed, vertically oriented pores with a typical dimension of about 10 μm. These pores are most likely formed during the expulsion of PLA disintegration products generated in the depth of the sintered area. On the top surface of the copper network, some round particles are also visible. These copper-based particles are not part of the initial composite and form during sintering. Their spherical geometries suggest that they are the result of local melting. Examples of these pores and particles are circled in blue and red respectively in FIG. 14A, which shows an SEM image of the composite top surface after 4 sintering steps at 100% laser power and 5 mm/s. In FIG. 14A the two pores are circled in blue, and the two spherical copper particles are circled in red.

To measure the depth of the sintered region, the samples were embedded in epoxy resin and cut perpendicular to the electrodes. After polishing the cut surface, optical microscopy was used to observe the sintered area. FIG. 14B shows the cross section of an electrode in enhanced colors. The sintered region is clearly visible in red color. Using the ImageJ software, the thickness of this layer is extracted for various sintering conditions. These results are presented in FIG. 14C. In FIG. 14C each point is an average over 6 measurements and the error bar is one standard deviation. For each graph one parameter is varied. The other parameter's value is indicated between brackets.

As can be seen, the depth of the sintered layer increases with the laser power and decreases with scan speed, but it remains essentially independent of the number of sintering steps. This result indicates that the laser energy is completely absorbed and/or reflected by the upper copper surface and is not transmitted into the composite (at least for the 450 nm wavelength). Accordingly, the region impacted by the laser depends on thermal (not optical) propagation of the energy.

The typical resistance of the sintered composite is 0.4 (2 for a 1 cm long, 1×0.1 mm electrode. In other words, the typical resistivity of this material is 4×10⁻⁴ Ω cm. Additionally, the electrodes sintered 4 times at 100% laser power and 5 mm/s are not deteriorated by a current of 0.6 A for 1 hour.

To evaluate the maximum current density through the sintered material of the present invention a fixed current was applied for one hour through an electrode. The electrode (sintered at 100% laser power, 4 sintering steps and 5 mm/s) was 1 mm wide, 10 mm long and about 100 μm thick. At 0.5 A and 0.6 A no change in resistance could be observed after one hour. At 0.7 A the electrode failed after 25 min. The failure was caused by the melting of the PLA surrounding the electrode. The maximum current density through the sintered material should thus be around 6 A/mm².

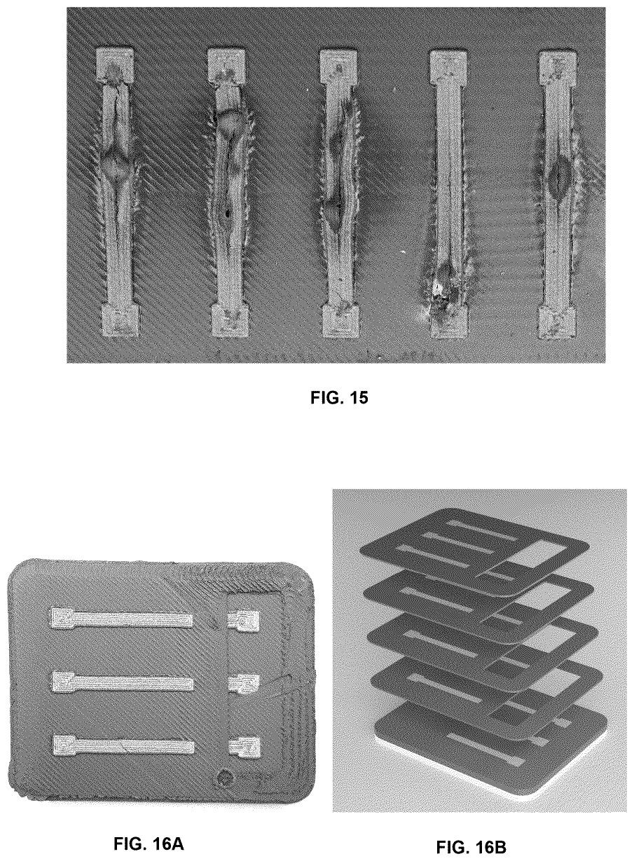

The failure seems to be caused by the local elevation of temperature at a random resistance point in the electrode. FIG. 15 shows 5 patterns destroyed by a 0.9 A current. Every time a local hot point appears at a random location and causes the local oxidation of the copper network, there is a further increase in the resistance.

To apply this technique to 3D printing, it is necessary to be able to stack sintered layers on top of each other. When the thickness of the printed layer is equal to or inferior to the depth of sintering, the totality of the printed composite can be sintered, hence a good electrical contact in the Z direction can be achieved. FIG. 14D shows the cross section of 5 stacked layers printed at 0.1 mm layer height and sintered on top of each other. In FIG. 14D the resistance value is an average over 10 measurements, and the error bar is one standard variation.

The cross section in FIG. 14D is extracted from a sample composed of 5 stacked sintered layers. This “complementary electrode structure” illustrated in FIG. 16A and FIG. 16B allows for testing of the resistance between the first and fifth layer. The resistance for this sample is 1.8Ω measured between the two contact pads, i.e., the resistance between the first and fifth layer is less than 1.8Ω, but one issue appears: The sintered lower layers are crushed and compressed when upper layers are printed on top. This phenomenon decreases the conductivity of the underlayer and increases the effective thickness of the top layer. In turn, the top layer becomes thicker than the sintering depth and some un-sintered material remains at the interface impeding good electrical contact. The crushing effect also causes printing failure on large, sintered areas.

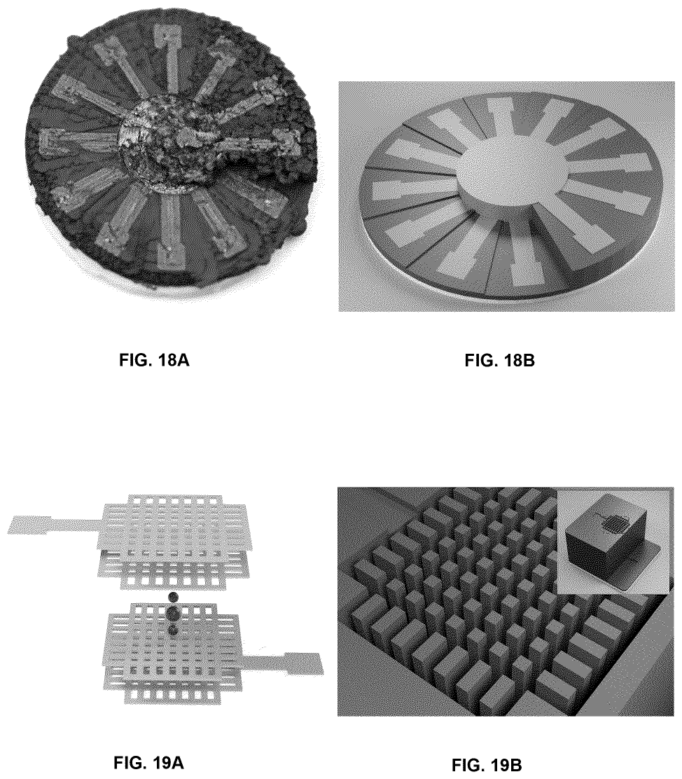

Stacking sintered layers is a crucial step to produce 3 dimensional parts. However, the porous nature of the sintered layer coupled with the pressure applied to the molten composite during printing, breaks the underlayer and causes printing defects. Those defects accumulate with each layer and ultimately cause the complete failure of the print. FIG. 18A illustrates this issue. This design contains 12 composite layers printed and sintered on top of one another. The central circle of the part is sintered at each layer and is conceived as a conductive via oriented in the Z direction. At each layer a contact pad is sintered on the side. As the print progresses the printing defaults accumulate in the central area. As the nozzle is no longer in contact with the printed part the composite is not deposited and sticks to the nozzle. This default propagates to all the over areas and causes the print quality to drop. In the absence of overlayers the central area is overexposed and oxidizes.

These issues increase when the sintered surface increases (9.5 mm²) in this example, and when the layer thickness decreases. At higher layer height the pressure of the molten composite decreases and the bridging capabilities of the system increase making it more tolerant to local defaults. However, layer height is limited to 0.1 mm by the sintering depth.

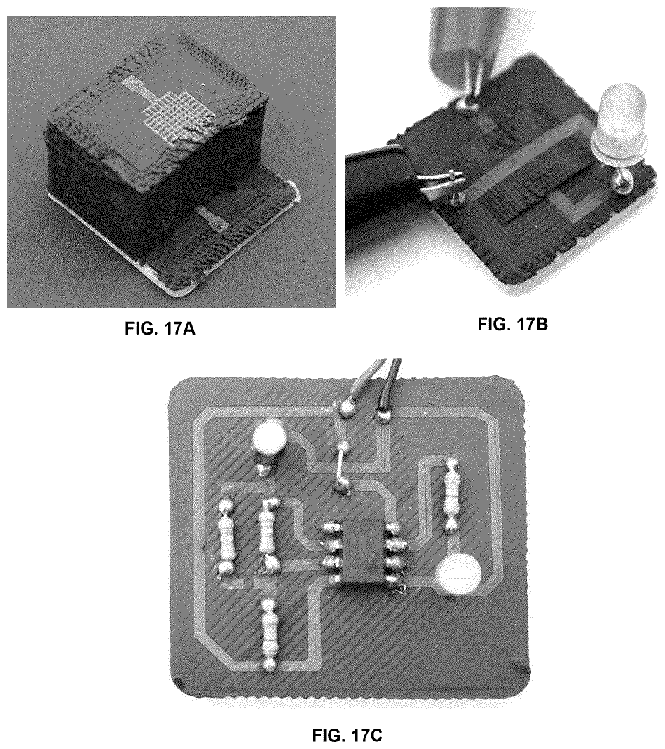

The destruction of the sintered layer under the pressure of the extruded material can be prevented by using a grid pattern. This pattern, visible in FIG. 17A, ensures that a portion of the composite remains un-sintered and mechanically strong to support the conductive copper mesh. Using this strategy, conductive vias can be printed oriented in the Z direction. The example shown in FIG. 17A has a resistance of 332 between two planes separated by 1 cm in the Z direction, i.e., the resistance between the top and bottom electrodes, which are separated by 1 cm (i.e. 100 printed layers) is 332.

As noted above, large, sintered areas are fragile due to the porous nature of the copper network and subsequent printing steps may damage that structure and reduce its conductivity. Smaller sintered regions are less sensitive to degradation due to the protective role of the sidewalls. The pressure applied by the printing head is spread over the open area of the nozzle: a circle of 0.6 mm diameter. Due to the high viscosity of the molten composite the pressure is reduced in the fragile area when the substrate is patterned with moves smaller than the nozzle. As further noted above, the smallest sintered lines achievable with the hybrid printer of the present invention in its current settings is 260 μm. Accordingly, a grid pattern was designed as represented in FIG. 19A with a line width of 260 μm. This pattern is used to drive the laser at each layer to form a conductive via oriented in the Z direction. However not all the composite material is converted. A portion remains dielectric and mechanically strong, it forms pillars that sustain the pressure during printing and protects the sintered material. These pillars are represented in FIG. 19B.

At a smaller Z scale the sintering process produces continuous track oversteps of 0.1 mm. Relying on this property it is possible to connect different layers by using slopes. FIG. 17B is an illustration of this process: A bridge with a 15° incline is used to allow the crossing of two distinct traces, i.e., one trace under the bridge and a second trace over the bridge. The second trace (passing on top of the bridge) is sintered after the whole part has been printed.

When designing electronic circuits, the capacity to manufacture crossing electrodes is critical. The grid structure discussed above with respect to FIG. 18 allows for the connection of plans separated by large distances, but it requires a significant footprint. In some cases, a simple design using slope geometry is preferable. This option is illustrated by the sample in FIG. 17B. The sintering process can produce continuous traces over small steps of 0.1 mm. This means that two layers printed on top of one another can be connected in a single sintering step if the layer height is less than or equal to 0.1 mm. With a slope (or stairs) design, multiple printed layers can be connected together. The only limitation is the focus distance of the laser due to collision risks between the printer and the object during sintering.

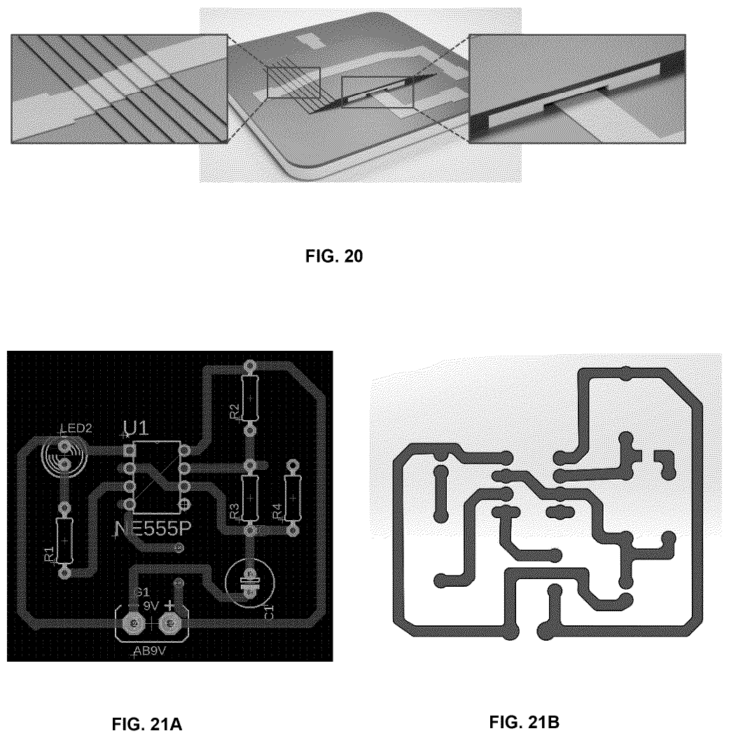

Using this method, the model in FIG. 20 was designed: Two electrodes share the same plan, but one crosses on top of the other using a bridge structure. The two sides of the bridges have the slope (stair) geometry with 15° incline and 0.1 mm steps visible in the left insert of FIG. 20. The printing sequence can be summarized as follows: 1) the PLA/composite base is printed 2) the bottom electrode is sintered 3) the bridge is printed 4) the top electrode is sintered. Due to the poor bridging characteristics of the composite filament, the bridge structure is composed of a PLA support structure, covered by a composite layer. This arrangement is visible in the right inset of FIG. 20. The PLA protects the bottom electrode from degradation.

Finally, the sintered composite has a low contact resistance and is compatible with soldering. FIG. 17C shows a picture of a simple circuit integrating conventional resistances, a capacitor, and a 555-timer microchip to make an LED flash. All the components were assembled using a soldering iron and tin solder. Laser sintering can be used to reconfigure the printed circuit and change the blinking frequency of the LED.

The demonstration circuit presented in FIG. 17C and whose printed circuit board is presented in FIG. 21A is a simple oscillating circuit based on a component NE555P (555 timer) and the charge-discharge of the capacitor C1 through the resistances R2, R3 and R4 (R1=R2=670Ω, R3=R4=47 kΩ and C1=10 uF). Initially the resistance R4 is not integrated in the circuit and the flashing period is 0.66 s. The trace between the resistors R3 and R4 is sintered, and these resistances are connected in parallel. Consequently, the charge/discharge equivalent resistance is divided by two and the flashing period becomes 0.33 s. This circuit was initially designed in EAGLE, then modelized in Solidworks to generate an STL model compatible with CURA. FIG. 21B is a 3D model of the circuit traces designed in Solidworks.

While PLA is preferred, other thermoplastic materials (ABS, PP, HIPS, TPU, PVA) would work in the same way. Further, while the embodiments discussed above use copper, other metals and metal oxides (e.g., tin oxide) could be used with this method. The only prerequisite being that the oxide form can be reduced efficiently by the gases emitted during the starch and thermoplastic disintegration. Also, starch has been described above as the reductive agent, but other materials such as cellulose may also be used.

As mentioned above a blue laser with an output of 5.5 W will work with the present invention. However, any laser with a wavelength from green to violet and an output from 3 to 15 W can produce a conductive copper mesh. The optimum should be around 8 W with the current composition and may be slightly different with other compositions.

The present invention is a new strategy for conductive/dielectric co-printing based on FDM additive manufacturing and laser sintering. To this end a composite filament has been developed relying on the in-situ reduction of copper oxides to produce highly conductive copper networks. A custom printer was used to sinter the composite at each layer of the printing process and to demonstrate centimeter scale 3-dimensional conductive vias, integrated inside a dielectric printed object. Thanks to its low resistivity (4×10⁻⁴ Ω cm) and high maximum current density (6 A/mm²), the sintered material can be used to interconnect and embed conventional electronic components, including an equivalent to conventional solder.

### REFERENCES

The cited references in this application are incorporated herein by reference in their entirety and are as follows:
[1] T. Rayna and L. Striukova, “Assessing the effect of 3D printing technologies on entrepreneurship: An exploratory study,” Technol. Forecast. Soc. Change, vol. 164, no. December 2020, p. 120483, March 2021, doi: 10.1016/j.techfore.2020.120483.
[2] J. P. Rett, Y. L. Traore, and E. A. Ho, “Sustainable Materials for Fused Deposition Modeling 3D Printing Applications,” Adv. Eng. Mater., vol. 23, no. 7, p. 2001472, July 2021, doi: 10.1002/adem.202001472.
[3] B. Shaqour et al., “Gaining a better understanding of the extrusion process in fused filament fabrication 3D printing: a review,” Int. J. Adv. Manuf. Technol., vol. 114, no. 5-6, pp. 1279-1291, May 2021, doi: 10.1007/s00170-021-06918-6.
[4] F. P. Chietera, R. Colella, and L. Catarinucci, “Dielectric resonators antennas potential unleashed by 3D printing technology: A practical application in the IoT framework,” Electron., vol. 11, no. 1, 2022, doi: 10.3390/electronics11010064.
[5] V. Chahal and R. M. Taylor, “A review of geometric sensitivities in laser metal 3D printing,” Virtual Phys. Prototyp., vol. 15, no. 2, pp. 227-241, April 2020, doi: 10.1080/17452759.2019.1709255.
[6] J. Zhang et al., “Silver Nanoparticles for Conductive Inks: From Synthesis and Ink Formulation to Their Use in Printing Technologies,” Metals (Basel)., vol. 12, no. 2, 2022, doi: 10.3390/met12020234.
[7] D. S. Vorunichev, “Investigation of the Possibilities of Printing Multilayer Printed Circuit Boards on a Dragonfly 3D Printer with Expired Nanoink,” in 2021 International Conference on Quality Management, Transport and Information Security, Information Technologies (IT&QM&IS), September 2021, pp. 476-479, doi: 10.1109/ITQMIS53292.2021.9642766.
[8] M. Abas, Q. Salman, A. M. Khan, and K. Rahman, “Direct ink writing of flexible electronic circuits and their characterization,” J. Brazilian Soc. Mech. Sci. Eng., vol. 41, no. 12, pp. 1-11, 2019, doi: 10.1007/s40430-019-2066-3.
[9] M. J. Kim et al., “One-step electrodeposition of copper on conductive 3D printed objects,” Addit. Manuf., vol. 27, no. November 2018, pp. 318-326, 2019, doi: 10.1016/j.addma.2019.03.016.
[10] P. F. Flowers, C. Reyes, S. Ye, M. J. Kim, and B. J. Wiley, “3D printing electronic components and circuits with conductive thermoplastic filament,” Addit. Manuf., vol. 18, no. 2017, pp. 156-163, 2017, doi: 10.1016/j.addma.2017.10.002.
[11] Z. Lei et al., “Novel electrically conductive composite filaments based on Ag/saturated polyester/polyvinyl butyral for 3D-printing circuits,” Compos. Sci. Technol., vol. 180, no. April, pp. 44-50, August 2019, doi: 10.1016/j.compscitech.2019.05.003.
[12] J. C. Tan and H. Y. Low, “Embedded electrical tracks in 3D printed objects by fused filament fabrication of highly conductive composites,” Addit. Manuf., vol. 23, no. June, pp. 294-302, October 2018, doi: 10.1016/j.addma.2018.06.009.
[13] B. Podsiadły, P. Matuszewski, A. Skalski, and M. Słoma, “Carbon Nanotube-Based Composite Filaments for 3D Printing of Structural and Conductive Elements,” Appl. Sci., vol. 11, no. 3, p. 1272, January 2021, doi: 10.3390/app11031272.
[14] J. Gong, O. Seow, C. Honnet, J. Forman, and S. Mueller, “MetaSense: Integrating Sensing Capabilities into Mechanical Metamaterial,” in The 34^{th} Annual ACM Symposium on User Interface Software and Technology, October 2021, vol. 1, no. 1, pp. 1063-1073, doi: 10.1145/3472749.3474806.
[15] Y. Chen, F. Pan, S. Wang, B. Liu, and J. Zhang, “Theoretical estimation on the percolation threshold for polymer matrix composites with hybrid fillers,” Compos. Struct., vol. 124, pp. 292-299, June 2015, doi: 10.1016/j.compstruct.2015.01.013.
[16] J. C. Tan and H. Y. Low, “Multi-materials fused filament printing with embedded highly conductive suspended structures for compressive sensing,” Addit. Manuf., vol. 36, no. May, p. 101551, 2020, doi: 10.1016/j.addma.2020.101551.
[17] X. Wang, M. Jiang, Z. Zhou, J. Gou, and D. Hui, “3D printing of polymer matrix composites: A review and prospective,” Compos. Part B Eng., vol. 110, pp. 442-458, 2017, doi: 10.1016/j.compositesb.2016.11.034.
[18] I. Blanco, “The Use of Composite Materials in 3D Printing,” J. Compos. Sci., vol. 4, no. 2, p. 42, April 2020, doi: 10.3390/jcs4020042.
[19] S. Majee et al., “Low temperature chemical sintering of inkjet-printed Zn nanoparticles for highly conductive flexible electronic components,” npj Flex. Electron., vol. 5, no. 1, pp. 1-8, 2021, doi: 10.1038/s41528-021-00111-1.
[20] S. Roshchupkin, A. Kolesov, A. Tarakhovskiy, and I. Tishchenko, “A brief review of main ideas of metal fused filament fabrication,” Mater. Today Proc., vol. 38, pp. 2063-2067, 2021, doi: 10.1016/j.matpr.2020.10.142.
C. Tosto, J. Tirillò, F. Sarasini, and G. Cicala, “Hybrid Metal/Polymer Filaments for Fused Filament Fabrication (FFF) to Print Metal Parts,” Appl. Sci., vol. 11, no. 4, p. 1444, February 2021, doi: 10.3390/app11041444.
[22] M. Mohammadizadeh et al., “Mechanical and thermal analyses of metal-PLA components fabricated by metal material extrusion,” Inventions, vol. 5, no. 3, pp. 1-11, 2020, doi: 10.3390/inventions5030044.
[23] C. Silbernagel, L. Gargalis, I. Ashcroft, R. Hague, M. Galea, and P. Dickens, “Electrical resistivity of pure copper processed by medium-powered laser powder bed fusion additive manufacturing for use in electromagnetic applications,” Addit. Manuf., vol. 29, no. August, 2019, doi: 10.1016/j.addma.2019.100831.
[24] [M. Abdelhafiz, K. S. Al-Rubaie, A. Emadi, and M. A. Elbestawi, “Process-Structure-Property Relationships of Copper Parts Manufactured by Laser Powder Bed Fusion,” Materials (Basel)., vol. 14, no. 11, p. 2945, May 2021, doi: 10.3390/ma14112945.
[25] P. H. Chiu, W. H. Cheng, M. T. Lee, K. Yasuda, and J. M. Song, “Low-thermal-budget photonic sintering of hybrid pastes containing submicron/nano cuo/cu20 particles,” Nanomaterials, vol. 11, no. 7, 2021, doi: 10.3390/nano11071864.
[26] M. K. Rahman, Z. Lu, and K.-S. Kwon, “Green laser sintering of copper oxide (CuO) nano particle (NP) film to form Cu conductive lines,” AIP Adv., vol. 8, no. 9, p. 095008, September 2018, doi: 10.1063/1.5047562.
[27] M. Joo, B. Lee, S. Jeong, and M. Lee, “Laser sintering of Cu paste film printed on polyimide substrate,” Appl. Surf. Sci., vol. 258, no. 1, pp. 521-524, October 2011, doi: 10.1016/j.apsusc.2011.08.076.
[28] W.-H. Cheng, P.-H. Chiu, Y.-J. Li, M.-T. Lee, K. Yasuda, and J.-M. Song, “Photonic Sintering of Composite Pastes with Copper Oxide Powders Using Different Light Sources,” vol. 2, pp. 11-12, 2021, doi: 10.23919/icep51988.2021.9451914.
[29] G. Qin, A. Watanabe, H. Tsukamoto, and T. Yonezawa, “Copper film prepared from copper fine particle paste by laser sintering at room temperature: Influences of sintering atmosphere on the morphology and resistivity,” Jpn. J. Appl. Phys., vol. 53, no. 9, p. 096501, September 2014, doi: 10.7567/JJAP.53.096501.
[30] X. Liu et al., “Thermal degradation and stability of starch under different processing conditions,” Starch-Stärke, vol. 65, no. 1-2, pp. 48-60, January 2013, doi: 10.1002/star.201200198.
[31] T. Ohkita and S.-H. Lee, “Thermal degradation and biodegradability of poly (lactic acid)/corn starch biocomposites,” J. Appl. Polym. Sci., vol. 100, no. 4, pp. 3009-3017, May 2006, doi: 10.1002/app.23425.
[32] R. K. Nekouei, F. Rashchi, and A. A. Amadeh, “Using design of experiments in synthesis of ultra-fine copper particles by electrolysis,” Powder Technol., vol. 237, pp. 165-171, 2013, doi: 10.1016/j.powtec.2013.01.032.
[33] F. Ippolito, G. Hübner, T. Claypole, and P. Gane, “Impact of bimodal particle size distribution ratio of functional calcium carbonate filler on thermal and flowability properties of polyamide 12,” Appl. Sci., vol. 11, no. 2, pp. 1-13, 2021, doi: 10.3390/app11020641.
[34] M. Ahmadifar, K. Benfriha, M. Shirinbayan, and A. Tcharkhtchi, Additive Manufacturing of Polymer-Based Composites Using Fused Filament Fabrication (FFF): a Review, vol. 28, no. 5. Springer Netherlands, 2021.
[35] T. Beran, T. Mulholland, F. Henning, N. Rudolph, and T. A. Osswald, “Nozzle clogging factors during fused filament fabrication of spherical particle filled polymers,” Addit. Manuf., vol. 23, no. May, pp. 206-214, October 2018, doi: 10.1016/j.addma.2018.08.009.
[36] B. P. Croom et al., “Mechanics of nozzle clogging during direct ink writing of fiber-reinforced composites,” Addit. Manuf., vol. 37, no. September 2020, p. 101701, January 2021, doi: 10.1016/j.addma.2020.101701.
[37] N. Doebelin and R. Kleeberg, “Profex: a graphical user interface for the Rietveld refinement program BGMN,” J. Appl. Crystallogr., vol. 48, no. 5, pp. 1573-1580, October 2015, doi: 10.1107/S1600576715014685.
[38] S.-Y. Fu, X.-Q. Feng, B. Lauke, and Y.-W. Mai, “Effects of particle size, particle/matrix interface adhesion and particle loading on mechanical properties of particulate-polymer composites,” Compos. Part B Eng., vol. 39, no. 6, pp. 933-961, September 2008, doi: 10.1016/j.compositesb.2008.01.002.
   While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A method for printing electronic components based on the hybridization of Fused Deposition Modeling (FDM) and laser sintering, comprising the steps of:
printing a layer of composite conductive metal-based thermoplastic polymer filament;
subjecting the filament of each layer of the component to a laser beam so as to simultaneously remove the polymer matrix in a restricted area after printing and sinter the conductive metal particles with the laser energy to form conductive paths; and
alternately repeating the printing and sintering steps on the successive printed layers placed one on top of the other until a complete component of arbitrary geometry, including both insulative and conductive structures, is formed layer-by-layer.

2. The method of claim 1 wherein the components is a 3D object.

3. The method of claim 1 wherein the filament is composed of native copper, cuprite oxide (Cu₂O), copper oxide (CuO) and starch particles encompassed in a Poly(lactic acid) (PLA) matrix.

4. The method of claim 3 wherein the filament is composed of 45 to 70V % of a thermoplastic matrix and 30 to 65V % of filler particle mix, wherein the filler particle mix is composed of 40 to 70 W % metal particles, 20 to 60 W % metal oxide and 0 to 15 W % reductive agent.

5. The method of claim 4 wherein the thermoplastic matrix is PLA matrix, the metal is copper, the metal oxide is CuO and/or Cu₂O, and the reductive agent is starch.

6. The method of claim 5 wherein the filament is a composite recipe composed of 55V % of a PLA matrix and 45V % particle mix, wherein the particle mix is 33 W % copper particles, 31 W % CuO and 10% Starch.

7. The method of claim 5 wherein the filament is a composite recipe composed of 55V % of a PLA matrix and 45V % particle mix, wherein the particle mix is composed of about 60 W % copper powder and 40 W % a mixture of CuO and starch, wherein the copper powder is composed of 55 W % Cu, 43 W % Cu2O, and 2 W % CuO″.

8. The method of claim 3 wherein the copper is in powder form with a mean particle size between 8 and 45 μm, the copper oxide is in powder form with a mean particle size between 100 nm and 5 μm and the starch is alimentation grade corn starch.

9. The method of claim 7 wherein the copper powder was produced by an electrolytic process comprising the steps of:
preparing an electrolyte by dissolving 15 g of copper chloride pentahydrate into 600 ml of deionized water in a glass container;
placing a rectangular copper electrode on one side of the container and of two roughly cylindrical copper ingots on the other side suspended by copper wires so that only the only the top surface of the ingots emerged from the electrolyte, the rectangular electrode and cylindrical ingots are separated from each other by about 50 mm;
placing the glass container inside a large box filled with 6 liters of water;
applying a DC voltage between the electrode and ingots to apply a constant current flow through the electrolyte;
stirring the electrolyte in the glass container at a speed to break any copper dendrites that form;
pipetting out copper powder accumulated in the bottom of the container; and
sieving the powder and retaining those powder particles below 20 μm.

10. The method of claim 5 wherein during sintering, the PLA and starch are disintegrated, and the copper oxides turn into a native copper mesh, forming a highly conductive interconnected network.

11. The method of claim 1 wherein the step of sintering involves use of a laser with a wavelength from green to violet and an output from 3 to 15 W.

12. The method of claim 11 wherein the step of sintering involves using a blue laser (450 nm) with a maximum nominal output of 5.5 W operating at 100% laser power with a laser spot of approximately 260 μm and scanning at 5 mm/s, while making up to four (4) sintering scan steps per layer.

13. The method of claim 12 wherein white PLA filament was used as the dielectric material.

14. The method of claim 1 further including the step of using a grid pattern of hard material at the printing location to direct the laser at each layer to form a conductive via oriented in the Z direction and prevent it from reaching all composite material so as to form pillars that are dielectric and mechanically strong in order to prevent the destruction of the sintered layer under the pressure of the extruded material.

15. The method of claim 1 wherein the step of sintering is performed under a flow of nitrogen.

16. The method of claim 1 further including the step of ironing by scanning the whole object's surface with the hot nozzle to melt away the peaks and fill the gaps.

17. The method of claim 1 wherein the composite copper-based thermoplastic polymer filament is formed according to the steps of:
grinding PLA pellets to below 500 μm particle size using;
drying the ground pellets for one night at 68 degrees;
thoroughly mixing 100 g of PLA powder with 217 g of copper powder, 108 g of CuO and 36 g of starch;
extruding the mixed powder while the temperatures from a feeding side to an extrusion side are controlled in zones between 165 and 190 degrees; and
cooling the filament with air and water while being driven by a belt puller to obtain a 1.75 mm diameter filament.

18. A method of printing electronic components comprising the steps of:
printing a first PLA/composite layer;
sintering a bottom electrode in the first layer;
printing a bridge layer of PLA/composite and
sintering a top electrode on the bridge layer.

19. A custom 3D printer comprising:
a frame with two towers extending in a Z direction from a base, each tower having two vertical shafts extending in the Z directions and separated from each other in an X direction and having a horizontal rail extending between them in the X direction, the two towers being separated from each other in a Y direction, a printing bed is located on the base and is movable by a motor in the Y direction, a bar extending between the two towers in the Y direction, the rails and bar forming a subframe movable in the vertical direction by a second motor;
a first FDM extrusion head being movable by a third motor along the rail of the first tower;
a laser head and a second FDM extrusion head movable by a fourth motor along the bar between the towers,
wherein the two extrusion heads move as they print PLA and copper composite, respectively, onto the printing bed as the printing bed moves in the Y direction;
wherein the laser is used to selectively sinter the PLA and copper composite; and
wherein as the sintered PLA and copper composite on the printing bed builds up to form a 3D object, the subframe is raised.

20. The custom 3D printer of claim 19 wherein the motors and extrusions operate under a program executed by a controller, wherein the program includes printing files, one including the commands to print both the dielectric PLA and the composite, and a second including only the sintering commands; and
wherein a routine is run by the controller to parse through the two files and generate a new G-code introducing the sintering section at the end of each composite printing section.

21. The custom 3D printer of claim 20 wherein the controller operates to have one conductive path bridge over another by operating in the following sequence:
a first PLA/composite layer is printed;
a bottom electrode is sintered on the first PLA/composite layer;
a bridge of PLA/composite layer is printed over the bottom electrode; and
a top electrode is sintered on the bridge layer.

22. The custom 3D printer of claim 19 wherein the PLA is printed using a 0.4 mm nozzle (line width is set at 0.4 mm) at 204 degrees with 100% infill, layer height is 0.2 mm, printing speed is 60 mm/s reduced at 30 mm/s for outer layers, and a print cooling fan is used after the first layer.

23. The custom 3D printer of claim 19 wherein the composite filament is printed with a 0.6 mm nozzle (line width is set at 0.6 mm) at 215 degrees, a wall thickness is set at 100 mm layer height is 0.1 mm and printing speed is 20 mm/s for all feature types.

24. The custom 3D printer of claim 23 wherein a small coating volume of 0.1 mm³ is used with a coasting speed of 80%, a retractation distance is set at 1 mm with 1 mm³ extra prime amount; and the cooling fan is disabled for the composite.

25. A sinterable FDM compatible thermoplastic filament comprising:
45 to 70V % of a thermoplastic matrix and
30 to 65V % of filler particle mix, and
wherein the filler particle mix is composed of 40 to 70 W % metal particles, 20 to 60 W % metal oxide and 0 to 15 W % reductive agent.
